(19) United States
(12) Patent Application Publication
(10) Pub. No.: US 2016/0242428 A1
(43) Pub. Date: Aug. 25, 2016

(54) ANTIMICROBIAL FORMULATIONS AND METHODS FOR SANITIZING MEAT PRODUCTS

(71) Applicant: Hydromer, Inc., Branchburg, NJ (US)

(72) Inventors: Manfred Dyck, Far Hills, NJ (US); Irina Grigorian, Bridgewater, NJ (US)

(21) Appl. No.: 15/043,248

(22) Filed: Feb. 12, 2016

Related U.S. Application Data
(60) Provisional application No. 62/115,962, filed on Feb. 13, 2015.

(51) Int. Cl. A23B 4/18; A01N 65/22; A01N 31/16; A01N 31/08

(52) U.S. Cl. CPC A23B 4/18; A01N 31/08; A01N 65/22; A01N 31/16; A23V 2002/00

(57) ABSTRACT

The present invention provides methods of reducing microbial population on a meat product during processing comprising contacting the meat product with a composition, wherein the composition comprises: (a) carvacrol and/or extract from oregano; and (b) a dispersing agent, wherein the ratio of (a) to (b) ranges from about 10:0.1 to about 10:2.

### CROSS REFERENCE TO RELATED APPLICATION

This application claims the benefit of U.S. Provisional Application No. 62/115,962, filed Feb. 13, 2015, which is incorporated herein by reference in its entirety.

### FIELD OF THE INVENTION

The present invention relates to antimicrobial formulations and sanitation methods for meat processing, for example, for processing poultry products.

### BACKGROUND OF THE INVENTION

In meat processing, e.g., poultry processing, microbiological control is of vital importance. By the nature of the processing, there are numerous opportunities for the poultry to be exposed to various pathogens in the form of mobile bacteria such as, for example, Escherichia coli, Salmonella enteritidis, Salmonella typhimurim, Campylobacter spp., and in the form of biofilms such as, for example, Listeria monocytogenes, Pseudomonasfluorescens spp., Enterococcus faecium, and Staphylococcus aureus.

For over a century, chlorination has been used as a cheap and convenient treatment for control of microbial contamination in foods. Chlorine is effective against a large variety of microorganisms. For instance, washing and chilling poultry carcasses in chlorinated water reduces common pathogenic microbes.

However, chlorine-based microbiocides have serious shortcomings. For example, chlorination lacks sufficient efficacy. According to a European Consumers' Organization study conducted in 2010, 82 percent of United States chickens that had been treated in chlorine baths still contained harmful pathogens. Essentially, the bath becomes a pathogen cesspool that contaminates the submerged chickens. For such reasons, the European Union has banned the importation of chickens from the United States.

Additionally, chlorination is malodorous and, in many cases, can exert an unpalatable bleaching effect upon poultry carcasses. Moreover, because of the spread of fecal matter associated with the evisceration of the fowl, fecal bacteria abound. This egregious condition in turn results in high nitrogen levels in the bath waters, and on wet surfaces such as cutting surfaces, conduits, tank surfaces, and other downstream equipment exposed to the bath waters. The active chlorine species of certain chlorine-based microbiocides tend to react with the nitrogenous species to form chloroamines which are lachrymators and corrosive to metallic surfaces. In fact, as little as 50 ppm of chlorine in bath waters containing nitrogenous impurities can produce quantities of air-borne lachrymators that are intolerable to workers. Furthermore, the consumption of chlorine in forming chloramines results in a significant loss of biocidal effectiveness inasmuch as the chloroamines are not biocidally-active species.

Even more hazardous are the potential health risks associated with the consumption of poultry containing residual chlorine and containing chlorine disinfection byproducts (DBP) formed during the treatment of chicken carcasses with chlorinated disinfectants. Examples of such DBP include trihalomethanes and haloacetic acids.

Consequently, extensive research has been done to examine acute and subacute toxicity and reproductive, teratogenic and developmental disorders resulting from exposure to chlorine and DBPs in human and animal models. Some studies have suggested a possible link between DBPs and cancer. According to the FDA, chlorine based washing solutions, commonly used for sanitization of poultry products, react with organic matter and form carcinogenic compounds (FDA, CDC, 2010).

In other studies, chloroform has been detected in chicken treated with aqueous chlorine (Robinson et al. 1981). In further studies, the formation of semicarbazide, a chemical belonging to a family of chemicals (hydrazines) known to cause cancer in animals, has been demonstrated following exposure of chicken flesh to aqueous chlorine (Hoenicke et al. 2004).

Clearly, the safety of food is a challenge worldwide. There is an urgent need for a safe alternative to chlorine-containing disinfectants used in the meat processing industry, including in the poultry industry.

### SUMMARY OF THE INVENTION

In one aspect, the present invention provides methods of reducing microbial populations on meat products during processing. In one embodiment, the method comprises contacting a meat product with a composition which includes: (a) carvacrol and/or other extract(s) from oregano; and (b) a dispersing agent. A typical ratio of (a) to (b) ranges from about 10:0.1 to about 10:2.

In one embodiment, the extract from oregano is eugenol, thymol or both. In one embodiment, the dispersing agent includes lecithins, castor oil esters, polyhydric compounds, lignin-like compounds, derivatives of fatty acids, diglycerides, silicon derivatives, polyethylene glycol derivatives, and combinations thereof.

In one embodiment, the present composition comprises carvacrol and lecithin. In one embodiment, the ratio of carvacrol to lecithin is about 5:2.

In one embodiment, the food product is poultry. In one embodiment, poultry is contacted with the present antimicrobial composition in scald-tanks, rinse systems, dip systems and/or in immersion chillers. In one embodiment, poultry is contacted with the antimicrobial composition during scalding, washing and/or chilling.

In one embodiment, the present antimicrobial composition is in an aqueous solution at about a 1:10 dilution.

In one embodiment, the present composition excludes chlorine-containing antimicrobials. Typical examples of chlorine-containing antimicrobials include chlorine per se; polychloro phenoxy phenols; sodium hypochlorite; acidulated sodium chlorite; chlorine dioxide; benzalkonium chloride; 8-chloro-9-hydroxy-8,9-deoxyasper-lactone; 9-chloro-8-hydroxy-8,9-deoxyasperlactone; and 9-chloro-8-hydroxy-8,9-deoxy-aspyrone.

### BRIEF DESCRIPTION OF THE DRAWINGS

FIG. 1 is a photograph showing the comparison of (A) a substrate that was immersed in water and fluorescein with (B) a substrate that was immersed in a composition of the present invention and fluorescein.

FIG. 2 is a schematic representation of the experimental protocol used to demonstrate chlorine disappearance and “the cesspool effect” for the evaluation of disinfectant compositions.

FIG. 3 shows the results of an experiment which analyzed the bacterial growth dependence on the number of dip times of the present compositions vis-à-vis a chlorine solution.

FIG. 4 shows the results of an experiment which analyzed the bacterial growth dependence on dip time for the present compositions vis-à-vis a chlorine solution.

FIG. 5 shows the results of an experiment which analyzed the preservative effect on chicken pieces of the present composition in comparison with deionized water.

### DETAILED DESCRIPTION OF THE INVENTION

The present invention is directed to methods to reduce pathogen contamination during food processing. The methods include the use of particular antimicrobial formulations suited for processing of food products, especially meat processing, including poultry processing, at or during one or more processing steps. The formulations do not contain potentially harmful ingredients, such as, for example, chlorine-containing ingredients.

### Antimicrobial Formulations

The present invention provides antimicrobial, herbal compositions which combine high antimicrobial efficacy and safety. The compositions are particularly well suited for use in sanitization in the meat processing industry, for example, in the poultry processing industry.

Throughout this specification, quantities are defined by ranges, and by lower and upper boundaries of ranges. Each lower boundary can be combined with each upper boundary to define a range. The lower and upper boundaries should each be taken as a separate element.

In one embodiment, the antimicrobial compositions of the present invention comprise i) carvacrol and/or extracts from oregano (Origanum vulgare), and ii) a water dispersing agent suitable for human composition.

Carvacrol (i.e., cymophenol, C₆H₃CH₃(OH)(C₃H₇)) is a monoterpenoid phenol. Carvacrol can be extracted from, for example, oregano, thyme, pepperwort (Lepidium), and wild bergamot. Typically, carvacrol is extracted from oregano. Typically, the carvacrol extract is highly enriched, for example, at least about 90% pure, 95% pure, 97%, or 99% pure. In addition to carvacrol, examples of suitable extracts from oregano include eugenol, and thymol.

Examples of water dispersing agents include lecithins, and lecithin derivatives; castor oil esters; polyhydric compounds; lignin-like compounds; derivatives of fatty acids; diglycerides; silicon derivatives; and polyethylene glycol derivatives.

Lecithins are any group of yellow-brownish fatty substances occurring in animal and plant tissues composed of phosphoric acid, choline, fatty acids, glycerol, glycolipids, triglycerides, and phospholipids (e.g., phosphatidylcholine, phosphatidylethanolamine, and phosphatidylinositol). An example of a lecithin derivative is a hydroxylated lecithin such as YELKIN® 1018 Lecithin.

In one embodiment, the preferred relative weight percentage of carvacrol/oregano extracts to a water dispersing agent ranges from about 10:0.1 to about 10:5. Examples of other lower boundaries of this range include 10:0.15; 10:1 and 10:1.2. Examples of other upper boundaries of this range include 10:2; 10:3 and 10:4. For instance, a preferred relative weight percentage of carvacrol to a lecithin ranges from about 5:2.

The compositions of the present invention can be supplied in any form. For example, the compositions can be supplied as concentrated liquids which can be suitable for dilution into end-use forms. Additionally, the compositions can be supplied diluted with water, e.g., their end-use aqueous forms.

In the end-use aqueous compositions of the present invention, the relative weight percentage of the “active ingredients” (i.e., of carvacrol/oregano extracts and a water dispersing agent) to water is about 1:25 to about 1:200. Examples of other preferred lower boundaries of this range include about 1:50; about 1:80; and 1:95. Examples of other preferred upper boundaries of this range include 1:100; 1:150; and 1:180. For example, in a preferred embodiment, the aqueous composition contains approximately 1 wt. % of carvacrol, 0.4 wt. % lecithin and 98.6 wt. % water.

It has surprisingly been discovered that the compositions of the present invention provide high antimicrobial efficacy in the food processing while excluding potentially hazardous chemicals. Examples of hazardous chemicals include chlorine-containing antimicrobials, and their disinfection byproducts; hydrogen peroxide; cetylperidinium chlorite; and peracetic acid.

Examples of chlorine-containing antimicrobials include chlorine per se; polychloro phenoxy phenols; sodium hypochlorite; acidulated sodium chlorite; chlorine dioxide; benzalkonium chloride; 8-chloro-9-hydroxy-8,9-deoxyasper-lactone; 9-chloro-8-hydroxy-8,9-deoxyasperlactone; and 9-chloro-8-hydroxy-8,9-deoxy-aspyrone.

In one embodiment, the active ingredients of the present invention consist essentially of (or consist of) carvacrol/oregano extracts and a water dispersing agent. That is, other ingredients that may materially affect the basic and novel characteristics of the active ingredients of the invention (e.g., of the present compositions) are specifically excluded from the composition.

The compositions of the present invention have many advantages in comparison with disinfectant agents used in the industry, e.g., in comparison with chlorine-containing disinfectant baths used in the poultry industry. Some of these advantages are effected by some of the basic and novel characteristics of the present compositions.

For example, the compositions of the present invention: i) are at least three times more effective than chlorine-containing disinfectants; ii) last three times longer as a chlorine-containing bath; iii) are natural and safe to use; iv) are cost comparative to currently used disinfectants; and v) “wet out” for uniform disinfection, i.e., have excellent “wettability.”

Wettability is a measure of the preferential tendency of immiscible fluids to spread over a solid surface (Civan and Donaldson, 1987 Grattoni et al., 1995). The present compositions uniformly wet out thereby enabling substantially full uniform coverage of food products. Consequently, the overall disinfection of the food product is superior to state-of-the-art methods. For example, the present compositions are water soluble allowing for even coverage of the entire poultry carcass. Example 1 shows how the present compositions “wet out” over an entire chicken piece.

In addition to the active ingredients, the compositions can include other non-toxic auxiliary agents, as long as such agents do not detract from the benefits provided by the present formulations. These agents can, for example, facilitate the delivery and/or stabilize the composition (e.g., cosmetic stabilizers) with respect to its shelf life or its actual applications. In the concentrate form, the formulations typically comprise about 20% to about 40%, by weight, of auxiliary agents. In the diluted form, the formulations typically comprise about 45% to about 55%, by weight, of auxiliary agents. Typical auxiliary agents are semethicone derivatives.

The antimicrobial compositions utilized in the methods of the present invention are effective for killing one or more of the food-borne pathogenic microbes associated with meat, particularly poultry, such as, for example, Salmonella typhimurium, Campylobacter spp., Vancomycyn-Resistant Enterococci, Methicillin-Resistant Staphylococcus aureus (MRSA), Escherichia coli, Norovirus, and the like. The compositions and methods of the present invention have activity against a wide variety of microorganisms such as Gram positive (for example, Listeria monocytogenes) and Gram negative (for example, Escherichia coli) bacteria, yeast, molds, bacterial spores, viruses, etc. The compositions and methods can kill a wide variety of microbes on the surface of meat, e.g., poultry, or in water used for washing or processing of meat, e.g., poultry.

### Food Products

The compositions of the present invention can be used to sanitize any food product. A food product generally includes any food substance that might require treatment with a disinfectant agent and that is edible with or without further preparation. Food products include, for example, meat (e.g., poultry, red meat, and pork), seafood, produce, eggs, egg products, ready-to-eat food, wheat, seeds, sprouts, seasonings, or a combination thereof. Red meat generally includes the meat of mammals such as beef, veal, mutton, lamb, rabbit, and horse. Produce generally includes fruits and vegetables and plants or plant-derived materials.

In one embodiment, the methods of the present invention can be applied to meat processing, especially poultry processing. A meat product generally includes various forms of animal flesh, including muscle, fat, organs, skin, bones, and body fluids and like components that form the animal. Animal flesh includes the flesh of birds, mammals, fishes, reptiles, amphibians, snails, clams, crustaceans, other edible species such as lobster, crab, etc. The forms of animal flesh include, for example, the whole or part of animal flesh, alone or in combination with other ingredients.

Poultry generally includes various forms of any bird kept, harvested, or domesticated for meat or eggs, and including chicken, turkey, ostrich, game hen, squab, guinea fowl, pheasant, quail, duck, goose, emu, or the like and the eggs of these birds. Poultry includes whole, sectioned, processed, cooked or raw poultry, and encompasses all forms of poultry flesh, by-products, and side products. The flesh of poultry includes muscle, fat, organs, skin, bones and body fluids and like components that form the animal. Forms of animal flesh include, for example, the whole or part of animal flesh, alone or in combination with other ingredients. Typical forms include, for example, processed poultry meat, such as cured poultry meat, sectioned and formed products, minced products, finely chopped products and whole products. Poultry processing methodology is well known in the art. The methods of the present invention can be carried out in accordance with such processes.

### Processing Methods

The antimicrobial compositions of the present invention can be used in any step of food processing to reduce pathogen contamination. For example, the compositions can be utilized in several target steps of carcass processing, such as in scald-tanks, in rinse and/or dip systems, and in immersion chillers. The compositions function efficiently in high temperature, high organic load, aqueous environments. Preferably, the antimicrobial compositions operate at a low pH, for example, around about pH 4 to about pH 8. The compositions are food safe additives (GRAS).

In one embodiment, food products are contacted with the antimicrobial compositions of the present invention. In a preferred embodiment, the concentrate composition is diluted into water employed for scalding, washing, chilling, or otherwise processing poultry.

Food products can be contacted by any method or apparatus suitable for applying the compositions. For example, the antimicrobial compositions can be delivered as a vented densified fluid composition, a spray of the compositions, by immersion in the compositions, by foam or gel treating with the compositions, or the like, or any combination thereof. Contact with a gas, a spray, a foam, a gel, or by immersion can be accomplished by a variety of methods known to those of skill in the art for applying compositions to food.

The present antimicrobial compositions can be employed for a variety of disinfection purposes, preferably as or for forming water-based systems for processing and/or washing animal carcasses. The present compositions and methods can be employed for processing meat at any step from gathering the live animals through packaging the final product. For example, the present compositions and methods can be employed for washing, rinsing, chilling, or scalding carcasses, carcass parts, or organs for reducing contamination of these items with spoilage/decay-causing bacteria, and pathogenic bacteria. As another example, the present compositions and methods can be employed for washing, disinfecting or sanitizing food products prior to harvesting.

### Carcass Processing

Before processing, live animals are generally transported to and gathered at the beginning of a processing line. Animals can be washed before entering the processing line. Processing typically begins with sacrificing the animal, typically by electrical stunning, followed by neck cutting and bleeding. A first washing step, known as scalding (e.g., submersion or immersion scalding), typically follows bleeding and loosens attachment of feathers, hair or hide of the animal. For example, poultry scalding loosens the attachment of feathers to the poultry skin. Submersion scalding can be accomplished according to the methods and employing compositions of the present invention. Submersion scalding typically includes immersing a stunned and bled animal (e.g., poultry) into a scalding hot bath of water or a liquid antimicrobial composition, typically at a temperature of about 50 to about 80° C., preferably about 50 to about 60° C. The liquid disinfection composition in the bath can be agitated, sonicated, or pumped to increase contact of the composition with the carcass. Scalding is generally conducted in a scald tank or trough, which contains the scalding liquid with sufficient liquid depth to completely submerse the poultry carcass. The carcass is generally transported through the tank or trough by conveyor at a speed that provides a few minutes in the scalding liquid.

According to the present invention, the scalding bath can include an antimicrobial composition of the present invention. Inclusion of the antimicrobial composition in the scalding bath allows operation at a reduced temperature while still reducing pathogen contamination levels. Such reduction in temperature, allowed by the antimicrobial composition, provides a yield increase for post-scalder carcasses. In the absence of the antimicrobial composition, operation of the scalder bath at lower temperatures generally results in greatly increased pathogen prevalence and in inferior feather, hair, or hide removal. For example, in poultry processing, it is general practice to maintain the scalder a minimum of about −1° C. above the maximum growth temperature of Salmonella (45° C.). Thus, without using an antimicrobial composition, the lowest temperatures suggested in the art for the scalder bath is about 50° C.

After submersion scalding, the carcass is typically defeathered, dehaired, or dehided, and, optionally, singed before the next washing process. In the case of poultry processing, this second washing process is generally known as “dress” rinsing, “New York dress” rinsing, or post-pick rinsing, which rinses residual feathers and follicle residues from the carcass. Dress rinsing typically includes spraying a picked carcass with water, typically at a temperature of about 5 to about 30° C. To increase contact with the carcass, the antimicrobial compositions in the spray water can be applied at higher pressures, flow rates, temperatures, or with agitation or ultrasonic energy. Dress rinsing is typically accomplished with a washing apparatus such as a wash or spray cabinet with stationary or moving spray nozzles. Alternatively, a “flood”-rinsing or liquid submersion washing apparatus can be used immediately after picking.

According to the present invention, post-scalding rinsing (e.g., poultry dress rinsing) can be accomplished employing an antimicrobial composition of the present invention.

Dress rinsing is typically a final washing step before dismembering the carcass. Dismembering can include removing the head, the feet, eviscerating, and removing the neck, in any order commonly employed in carcass processing. The dismembered and eviscerated carcass can then be subjected to a washing step. In poultry processing, such washing step is known as inside-outside bird washing (IOBW). Inside-outside bird washing washes the interior (body cavity) and exterior of the bird. Inside-outside bird washing typically includes rinsing the interior and exterior surfaces of the carcass with streams or floods of water, typically at a temperature of about 5 to about 30° C. To increase contact with the carcass, the antimicrobial compositions in the spray water can be applied at higher pressures, flow rates, temperatures, or with agitation or ultrasonic energy. Inside-outside bird washing is generally accomplished by an apparatus that floods the bird carcass with streams of water in the inner cavity and over the exterior of the carcass. Such an apparatus can include a series of fixed spray nozzles to apply the antimicrobial composition to the exterior of the bird and a rinse probe or bayonet that enters and applies antimicrobial composition to the body cavity.

According to the present invention, final washing (e.g., IOBW in poultry processing) can be accomplished employing a antimicrobial composition of the present invention.

After washing, both the interior and the exterior of the bird can be subjected to further decontamination. This further decontamination can be accomplished in part by a step commonly known as spray rinsing, sanitizing rinsing, or finishing rinsing. Such rinsing typically includes spraying the interior and exterior surfaces of the carcass with water, typically at a temperature of about 5 to about 30° C. To increase contact with the carcass, the antimicrobial compositions in the spray water can be applied using fixed or articulating nozzles, at higher pressures, flow rates, temperatures, with agitation or ultrasonic energy, or with rotary brushes. Spray rinsing is typically accomplished by an apparatus such as a spray cabinet with stationary or moving spray nozzles. The nozzles create a mist, vapor, or spray that contacts the carcass surfaces.

According to the present invention, antimicrobial compositions of the present invention can be used in the spray rinsing, sanitizing rinsing, or finishing rinsing.

After spray rinsing, the carcass can be made ready for packaging or for further processing by chilling, specifically submersion chilling or air chilling. Submersion chilling both washes and cools the bird to retain quality of the meat. Submersion chilling typically includes submersing the carcass completely in water or slush, typically at a temperature of less than about 5° C., until the temperature of the carcass approaches that of the water or slush. Chilling of the carcass can be accomplished by submersion in a single bath, or in two or more stages, each of a lower temperature. Water can be applied with agitation or ultrasonic energy to increase contact with the carcass. Submersion chilling is typically accomplished by an apparatus such as a tank containing the chilling liquid with sufficient liquid depth to completely submerse the poultry carcass. The carcass can be conveyed through the chiller by various mechanisms, such as an auger feed or a drag bottom conveyor. Submersion chilling can also be accomplished by tumbling the carcass in a chilled water cascade.

According to the present invention, submersion chilling can be accomplished employing an antimicrobial composition of the present invention.

Like submersion chilling, air chilling or cryogenic chilling cools the carcass to retain quality of the meat. Air cooling can be less effective for decontaminating the carcass, as the air typically would not dissolve, suspend, or wash away contaminants. Air chilling with a gas including an antimicrobial composition can, however, reduce the burden of microbial, and other, contaminants on the carcass. Air chilling typically includes enclosing the carcass in a chamber having a temperature below about 5° C. until the carcass is chilled. Air chilling can be accomplished by applying a cryogenic fluid or a gas or a refrigerated gas as a blanket or spray.

Air chilling can be accomplished employing an antimicrobial composition of the present invention. For example, air chilling compositions can include a gaseous or densified fluid antimicrobial composition.

After chilling, the carcass can be subjected to additional processing steps including weighing, quality grading, allocation, portioning, deboning, and the like. This further processing can also include methods or compositions according to the present invention. For example, it can be advantageous to wash poultry portions, such as legs, breast quarters, wings, and the like, formed by portioning the bird. Such portioning forms or reveals new meat, skin, or bone surfaces which may be subject to contamination and benefit from treatment with a disinfection composition. Similarly, deboning a carcass, or a portion of a carcass, can expose additional areas of the meat or bone to microbial contamination. Washing the deboned carcass or portion with the present antimicrobial composition can advantageously reduce any such contamination. In addition, during any further processing, the deboned meat can also come into contact with microbes, for example, on contaminated surfaces. Washing the deboned meat with the present compositions can reduce such contamination. Washing can be accomplished by spraying, immersing, tumbling, or a combination thereof, or by applying a gaseous or densified fluid antimicrobial composition.

Usable side products of meat processing include heart, liver, and gizzard (e.g. giblets), neck, and the like. These are typically harvested later in processing, and are sold as food products. These side products can also be washed with an antimicrobial composition in methods of the present invention. Typically, these side products will be washed after harvesting from the carcass and before packaging. They can be washed by submersion or spraying, or transported in a flume including the antimicrobial compositions. They can be contacted with an antimicrobial composition according to the invention in a giblet chiller or ice chiller.

The carcass, meat product, carcass portion, carcass side product, or the like can be packaged before sending it to more processing, to another processor, into commerce, or to the consumer. Any such product can be washed with a water based antimicrobial composition, which can then be removed (e.g., drained, blown, or blotted) from the poultry.

Preferred methods of the present invention include agitation or sonication of the use composition, particularly as a concentrate is added to water to make the use composition. Preferred methods include water systems that have some agitation, spraying, or other mixing of the solution. The carcass product can be contacted with the compositions effective to result in a reduction significantly greater than is achieved by washing with water, or at least about a 50% reduction, at least about a 90% reduction, at least about a 99% reduction in the resident microbial preparation.

The present methods require a certain minimal contact time of the composition with food product for occurrence of significant disinfection effect. The contact time can vary with concentration of the use composition, method of applying the use composition, temperature of the use composition, amount of soil and/contamination on the food product, number of microorganisms on the food product, type of antimicrobial formulation, or the like. Preferably the exposure time is at least about 5 to about 15 seconds.

### Spraying

A preferred method for carcass washing employs a pressure spray of the antimicrobial composition. During application of the spray on the food product, the surface of the product can be moved with mechanical action, preferably agitated, rubbed, brushed, etc. Agitation can be by physical scrubbing of the meat product (e.g., poultry carcass), through the action of the spray under pressure, through sonication, or by other methods. Agitation increases the efficacy of the spray in killing micro-organisms, perhaps due to better exposure of the antimicrobial composition into the crevasses or small colonies containing the micro-organisms. The spray, before application, can also be heated to a temperature of about 15° to 60° C., preferably about 20° C., to increase efficacy.

Application of the antimicrobial composition by spray can be accomplished using a manual spray wand application, an automatic spray of food product moving along a production line using multiple spray heads to ensure complete contact or other spray means. One preferred automatic spray application involves the use of a spray booth. The spray booth substantially confines the sprayed composition to within the parameter of the booth. For example, in poultry processing, the production line moves the poultry product through the entryway into the spray booth in which the poultry product is sprayed on all its exterior surfaces with sprays within the booth. After a complete coverage of the material and drainage of the material from the poultry product within the booth, the poultry product can then exit the booth in a fully treated form. The spray booth can include steam jets that can be used to apply the antimicrobial compositions of the invention. These steam jets can be used in combination with cooling water to ensure that the treatment reaching the poultry product surface is less than 65° C., preferably less than 60 ° C. The temperature of the spray on the poultry product is important to ensure that the poultry product is not substantially altered (cooked) by the temperature of the spray. The spray pattern can be virtually any useful spray pattern.

### Immersing

Immersing a food product in a liquid antimicrobial composition can be accomplished by any of a variety of methods known to those of skill in the art. During processing of, for example, a poultry product, the poultry product can be immersed into a tank containing a quantity of washing solution containing the antimicrobial composition. The washing solution is preferably agitated to increase the efficacy of the solution and the speed in which the solution reduces micro-organisms accompanying the food product. Agitation can be obtained by conventional methods, including ultrasonics, aeration by bubbling air through the solution, by mechanical methods, such as strainers, paddles, brushes, pump driven liquid jets, or by combinations of these methods. The antimicrobial composition can be heated to increase the efficacy of the solution in killing micro-organisms. After the food product has been immersed for a time sufficient for the desired effect, the food product can be removed from the bath or flume and the antimicrobial composition can be rinsed, drained, or evaporated off the food product. It is preferable that the poultry product be immersed in the washing solution after the poultry product has been eviscerated.

### Foam Treating

In another alternative embodiment of the present invention, the food product can be treated with a foaming version of the antimicrobial composition. The foam can be prepared by mixing foaming surfactants with the antimicrobial composition at time of use. The foaming surfactants can be nonionic, anionic, or cationic in nature. Examples of useful surfactant types include, but are not limited to the following: alcohol ethoxylates, alcohol ethoxylate carboxylate, amine oxides, alkyl sulfates, alkyl ether sulfate, sulfonates, quaternary ammonium compounds, alkyl sarcosines, betaines and alkyl amides. The foaming surfactant is typically mixed at time of use with the antimicrobial formulation or composition. At time of use, compressed air can be injected into the mixture, and then applied to the food product surface through a foam application device such as a tank foamer or an aspirated wall mounted roamer.

### Gel Treating

In another alternative embodiment of the present invention, the food product can be treated with a thickened or gelled version of the antimicrobial composition. In the thickened or gelled state the antimicrobial composition remains in contact with the food product surface for longer periods of time, thus increasing the antimicrobial efficacy. The thickened or gelled solution will also adhere to vertical surfaces. The composition can be thickened or gelled using existing technologies such as: xanthan gum, polymeric thickeners, cellulose thickeners or the like. Rod micelle forming systems such as amine oxides and anionic counter ions could also be used. The thickeners or gel forming formulations can be used either in the concentrated product or mixing with the antimicrobial composition, at time of use. Typical use levels of thickeners or gel formulations range from about 100 ppm to about 10 wt-%.

### EXAMPLES

### Example 1

### An Aqueous Formulation of the Present Invention

| | |
|---|---|
| Deionized Water | 98.6% |
| Lecithin | 0.4% |
| Highly enriched oregano oil | 1% |
| (Present Composition) | |
| Total | 100% |

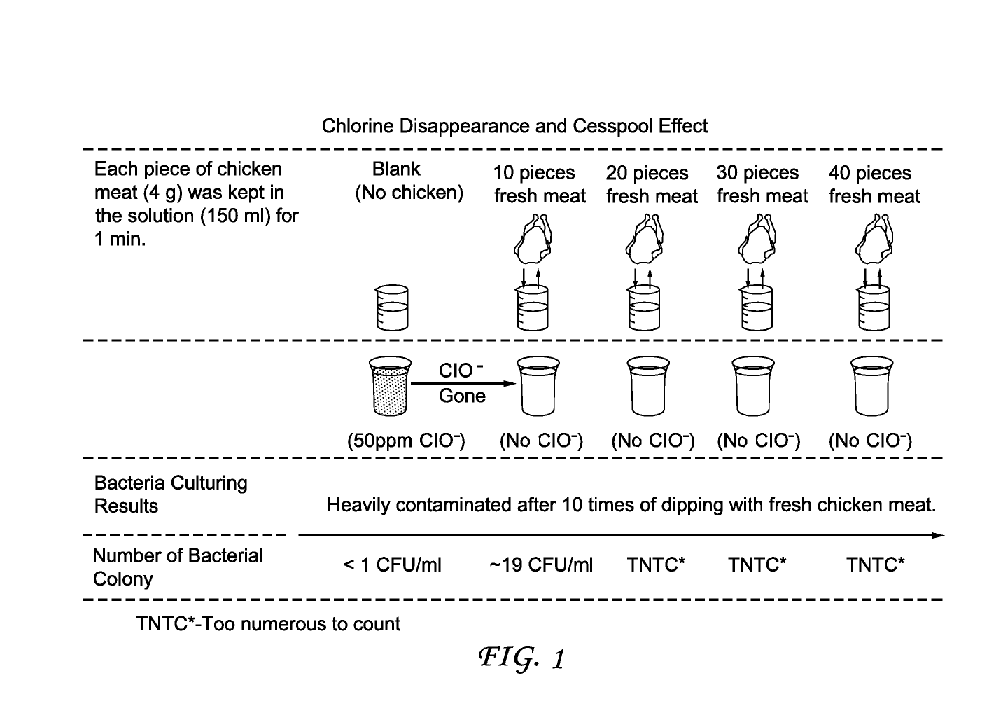

FIG. 1 is a photograph showing the comparison of a substrate that was immersed in: (A) water and fluorescein or (B) a composition of the present invention (i.e., Spice Hygiene™) and fluorescein. Fluorescein shows fluorescent color on black light (or under UV illumination). From the photograph, it is apparent that substrate B is fully covered with the present composition.

### Example 2

### Procedure Used for Detection of Chlorine Ion in Water

Syringaldazine, a reagent used to indicate the presence of free chlorine in water, was utilized in the present evaluations. (“Use of syringaldazine in a photometric method for estimating ‘free’ chlorine in water,” R. Bauer, C. O. Rupe, Analytical Chemistry 1971, 43:421-425.)

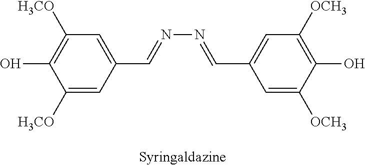 [SMILES: COc1cc(/C=N/N=C/c2cc(OC)c(O)c(OC)c2)cc(OC)c1O]

Procedure: Aqueous solutions containing varied concentrations (50 ppm, 5 ppm, 0.5 ppm, and 0.1 ppm) of chlorine were prepared. A standard solution of syringaldazine (0.01M) in ethanol was prepared and added into the chlorine solutions in a volume of 0.2 ml. The mixed solutions were stirred for 3 minutes at room temperature while the color became stable. Syringaldazine was used to detect the presence of free chlorine in water at the varied concentrations. The color intensity of the solutions decreases commensurate with the concentration of chlorine ion.

### Example 3

### Detection of Chlorine Ion in Chicken Dipping Solution

As indicated in Example 2, the color of the solutions diminished dramatically from 50 ppm to 0.1 ppm chlorine. Therefore such method was used to visualize the presence of chlorine ions in solutions after chicken dipping. The procedure follows below.

Chicken Dip Procedure:

1. Prepared 4 solutions containing 50 ppm of ClO⁻ with deionized water.

2. Cut chicken meat into pieces with similar surface areas (i.e., ˜2 cm*2 cm). The weight was approximately 3.5 g per piece. Chicken meat was exposed in air for 5 hours before use.

3. Dipped and held chicken meat in each solution for 1 minute. A new piece of chicken meat was used every time before dipping. The volume of stock solutions was 150 ml.

4. Qualitative evaluation of the presence of chlorine in the stock solution after 10, 20, 30 and 40 times of dipping experiments.

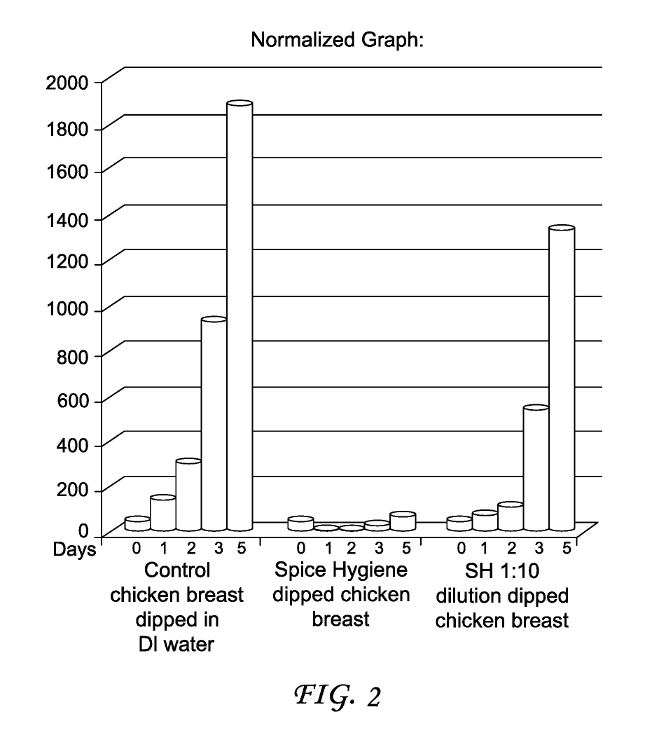

FIG. 2 is a schematic representation of the experimental protocol used in the present invention to demonstrate the chlorine disappearance and the “cesspool effect.” In particular, after even 10 dippings, the chlorine in the solution was gone. After 10 dippings, the Bacteria Colony Forming Units increased from less than about 1 CFU/ml to about 19 CFU/ml. After 20 dippings, the bacteria CFU was too numerous to count.

### Example 4

### Evaluation of Bacterial Growth Dependence on Number of Dipping Times

The bacterial growth dependent on the number of times a chicken piece was dipped was evaluated to compare a composition of the present invention (i.e., Spice Hygiene™) to chlorine solution. An aqueous composition of the present invention was used in a 1:10 dilution with water.

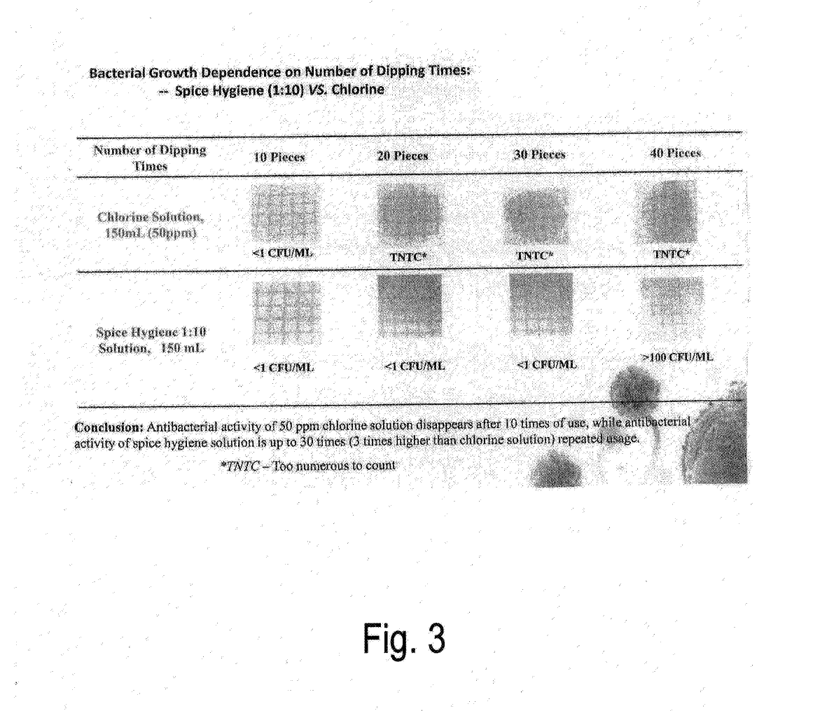

The results of the experiment are shown in FIG. 3. It was concluded that the antibacterial activity of 50 ppm chlorine solution disappears after 10 times of use; while the antibacterial activity of the composition of the present invention is up to 30 times of use (i.e., 3 times higher than the chlorine solution). In particular, for the 150 ml (50 ppm) chlorine solution, after 10 dippings, the bacterial count increased from less than about 1 CFU/ml to being too numerous to count. In contrast, for the 150 ml (1:10 dilution) composition of the present invention, the bacterial count remained less than 1 CFU/ml for up to 30 dippings.

### Example 5

### Evaluation of Bacterial Growth Dependence on Duration Time after Dipping

The bacterial growth dependent on time duration after a chicken piece was dipped was evaluated to compare a composition of the present invention (i.e., Spice Hygiene™) to chlorine solution. An aqueous composition of the present invention was used in a 1:10 dilution with water.

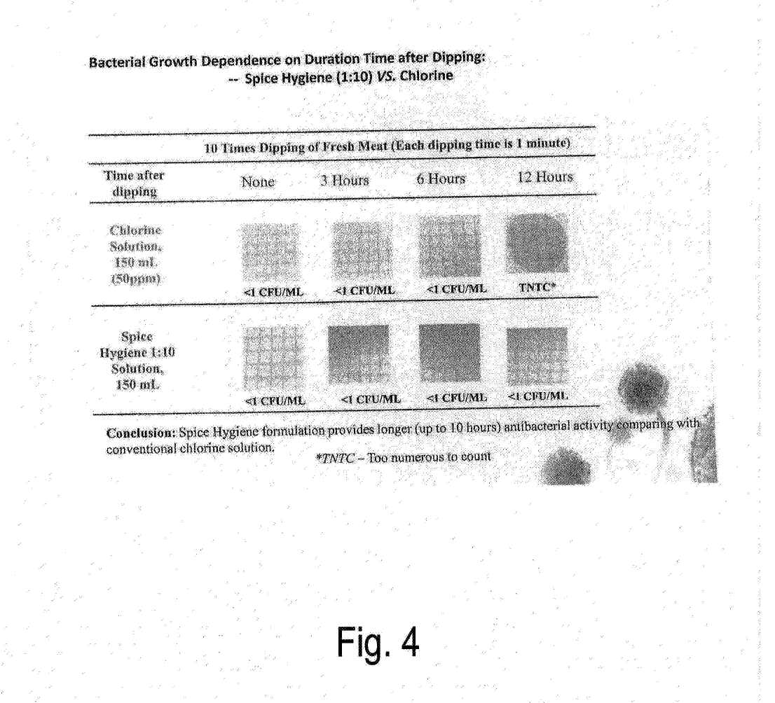

The results of the experiment are shown in FIG. 4. It was concluded that the composition of the present invention provides longer (up to 10 hours) antibacterial activity vis-à-vis the chlorine solution. In particular, for the 150 ml (50 ppm) chlorine solution, twelve hours after 10 dippings, the Bacteria Colony Forming Units was too numerous to count. In contrast, for the 150 ml (1:10 dilution) composition of the present invention, the bacterial count remained less than 1 CFU/ml for up to at least 12 hours after 10 dippings.

### Example 6

### Evaluation of the Preservative Effect of the Present Composition

Two equal pieces of chicken meat were dipped for 30 seconds in i.) deionized water (DI) (i.e., control), and ii) the present composition (i.e., Spice Hygiene™). After dipping, the pieces were kept at 4° C. for 24-72 hours. Bacterial surface contaminations were measured as “colony forming units” (i.e., CFU) before dipping (as Point 0) and after dipping at 24, 48 and 72 hours, and at 5 days. The following table shows the results.

Aerobic Bacteria Contamination Counts/Repeat

| | Control-CFU | Instant composition-CFU |
|---|---|---|
| Point 0 | 8 | 12 |
| At 24 hours at 4° C. | 21 | 0 |
| At 48 hours at 4° C. | 49 | 0 |
| At 72 hours at 4° C. | 149 | 7 |
| At 5 days | Over 300 | 18 |

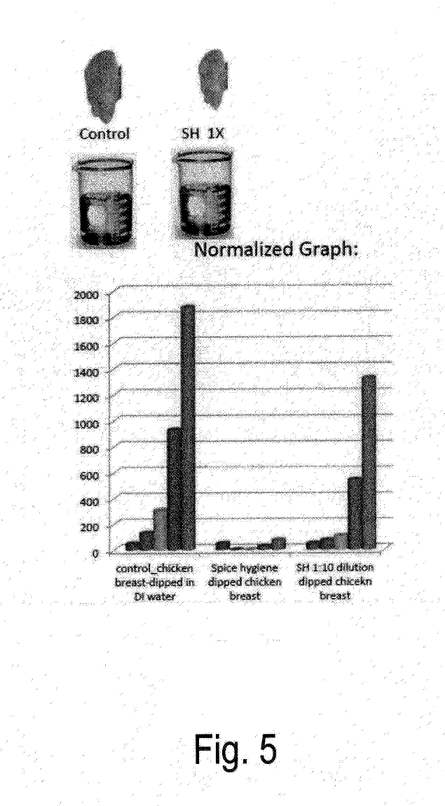

The results of the experiment are also shown in FIG. 5. This example demonstrates that the present composition preserves chicken meat from aerobic contamination for 5 days; whereas, the control meat dipped in DI water became heavily contaminated after 48 hours kept at 4° C.

While there have been described what are presently believed to be the preferred embodiments of the present invention, those skilled in the art will realize that changes and modifications may be made thereto without departing from the spirit of the invention, and it is intended to claim all such changes and modifications as fall within the true scope of the invention.

1. A method of reducing microbial population on a meat product during processing comprising contacting the meat product with a composition, wherein the composition comprises: (a) carvacrol and/or extract from oregano; and (b) a dispersing agent, wherein the ratio of (a) to (b) ranges from about 10:0.1 to about 10:2.

2. The method according to claim 1 wherein the extract from oregano is selected from at least one of the group consisting of eugenol and thymol.

3. The method according to claim 1 wherein the dispersing agent is selected from at least one of the group consisting of lecithins, castor oil esters, polyhydric compounds, lignin-like compounds, derivatives of fatty acids, diglycerides, silicon derivatives, and polyethylene glycol derivatives.

4. The method according to claim 1 wherein the composition comprises carvacrol and the lecithin.

5. The method according to claim 4 wherein the ratio of carvacrol to the lecithin is about 5:2.

6. The method according to claim 1 wherein the food product is poultry.

7. The method according to claim 6 wherein the poultry is contacted with the antimicrobial composition in scald-tanks, rinse systems, dip systems or in immersion chillers.

8. The method according to claim 6 wherein the poultry is contacted with the antimicrobial composition during scalding, washing and/or chilling.

9. The method according to claim 8 wherein the antimicrobial composition is in an aqueous solution at about a 1:10 dilution.

10. The method according to claim 1 wherein the composition excludes chlorine-containing antimicrobials.

11. The method according to claim 10 wherein the chlorine-containing antimicrobial is selected from the group consisting of chlorine; polychloro phenoxy phenols; sodium hypochlorite; acidulated sodium chlorite; chlorine dioxide; benzalkonium chloride; 8-chloro-9-hydroxy-8,9-deoxyasper-lactone; 9-chloro-8-hydroxy-8,9-deoxyasperlactone; and 9-chloro-8-hydroxy-8,9-deoxy-aspyrone.
